(19) United States
(12) Patent Application Publication
(10) Pub. No.: US 2024/0028747 A1
(43) Pub. Date: Jan. 25, 2024

(54) PREVENTING ACCESS TO DATA BASED ON LOCATIONS

(71) Applicant: Micron Technology, Inc., Boise, ID (US)

(72) Inventor: Christian M. Gyllenskog, Meridian, ID (US)

(21) Appl. No.: 17/869,677

(22) Filed: Jul. 20, 2022

(51) Int. Cl. G06F 21/60; H04L 67/52; G06F 21/62

(52) U.S. Cl. CPC G06F 21/602; H04L 67/52; G06F 21/62

(57) ABSTRACT

Data can be stored in a computing device as encrypted to prevent the data from being read and/or modified without being decrypted using cryptographic information. To prevent the data from being decrypted in locations other than a secure location, the cryptographic information can be removed logically and physically from the computing device when it is determined that the computing device has left the secure location.

### TECHNICAL FIELD

The present disclosure relates generally to semiconductor memory and methods, and more particularly, to apparatuses, systems, and methods for preventing access to data based on locations.

### BACKGROUND

Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random access memory (DRAM), static random access memory (SRAM), synchronous dynamic random access memory (SDRAM), and thyristor random access memory (TRAM), among others. Non-volatile memory can provide persistent data by retaining stored data when not powered and can include NAND flash memory, NOR flash memory, and resistance variable memory such as phase change random access memory (PCRAM), resistive random access memory (RRAM), and magnetoresistive random access memory (MRAM), such as spin torque transfer random access memory (STT RAM), among others.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system.

### BRIEF DESCRIPTION OF THE DRAWINGS

FIG. 1 is a functional block diagram in the form of a computing device including a host and a memory system in accordance with a number of embodiments of the present disclosure.

FIG. 2 is an example network for preventing access to data based on locations in accordance with a number of embodiments of the present disclosure.

FIG. 3 is a flow diagram representing an example method for preventing access to data based on locations in accordance with a number of embodiments of the present disclosure.

### DETAILED DESCRIPTION

A memory device can store data that may be desired to be secure such that the data may be accessed in limited circumstances and/or with limited means. To ensure that data remain secure, the data can be cryptographically encrypted such that the data are not accessible (e.g., to read, write, modify, and/or make the data readable to a user) without being decrypted using, for example, cryptographic information (e.g., a key).

Embodiments of the present disclosure are directed to preventing access to data based on locations to ensure that a computing device is prevented from accessing/decrypting secure data (e.g., stored on the device) when not in a secure location. For example, it may be desirable for an employee to have access to data stored on a computing device while at a secure location such as at the office but to not have access to the data stored on the computing device when outside of the office (e.g., at home). As used herein, the term “secure data” refers to data that are desired to be secure such that they may be accessed in limited circumstances and/or means. As used herein, the term “secure location” refers to one or more areas (e.g., a single area or multiple discontinuing areas) that are designated by a network administrator (that has generated and provides the cryptographic key) and where the computing device is permitted to receive and keep a cryptographic key to decrypt and access the secure data using the cryptographic key (e.g., provided by the network administrator). For example, the computing device receives the cryptographic key (e.g., to decrypt and access the secure data) when it is determined that the computing device has entered and/or is in the secure location such that the computing device can decrypt the secure data using the cryptographic key, which allows a user of the computing device to read, write, and/or modify the secure data, and/or allows the secure data become readable to the user. In contrast, when it is determined that the computing device has left and/or is not in the secure location, the computing device can be forced to remove the cryptographic key from the computing device. As used herein, removal of the cryptographic key includes both logical and physical erasure such that the computing device no longer stores the cryptographic key to decrypt the secure data. This can allow the secure data stored in the computing device accessible only when the computing device is in and/or remains in the secure location and ensure that the secure data are not accessible when not in the secure location. Accordingly, embodiments of the present disclosure eliminate a need to physically erase the secure data itself; thereby, avoiding moving the secure data (which can often be of a large size) into and/or out of the computing device each time the computing device has entered and/or left the secure location.

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and structural changes may be made without departing from the scope of the present disclosure.

As used herein, designators such as “X,” “N,” etc., particularly with respect to reference numerals in the drawings, indicate that a number of the particular feature so designated can be included. It is also to be understood that the terminology used herein is for the purpose of describing particular embodiments only, and is not intended to be limiting. As used herein, the singular forms “a,” “an,” and “the” can include both singular and plural referents, unless the context clearly dictates otherwise. In addition, “a number of,” “at least one,” and “one or more” (e.g., a number of memory banks) can refer to one or more memory banks, whereas a “plurality of” is intended to refer to more than one of such things.

Furthermore, the words “can” and “may” are used throughout this application in a permissive sense (i.e., having the potential to, being able to), not in a mandatory sense (i.e., must). The term “include,” and derivations thereof, means “including, but not limited to.” The terms “coupled” and “coupling” mean to be directly or indirectly connected physically or for access to and movement (transmission) of commands and/or data, as appropriate to the context.

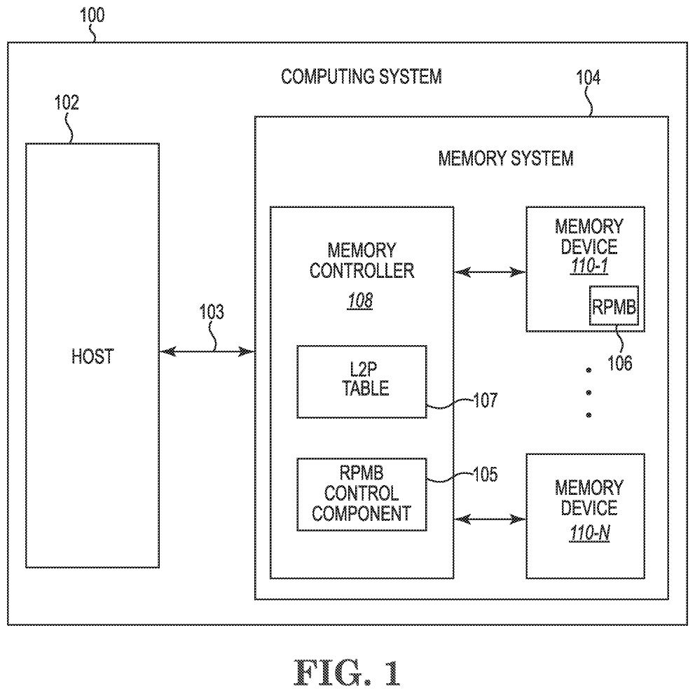

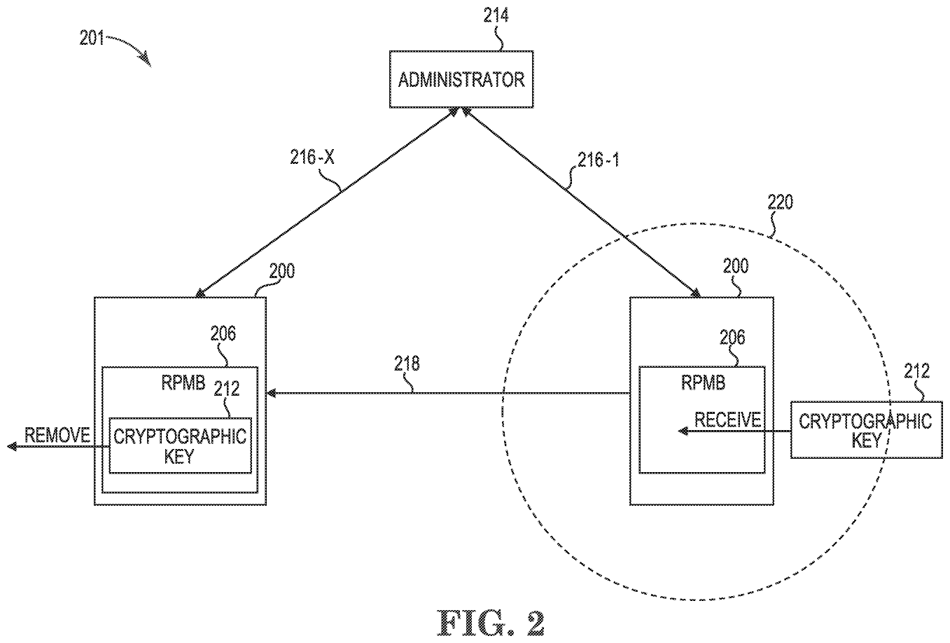

The figures herein follow a numbering convention in which the first digit or digits correspond to the figure number and the remaining digits identify an element or component in the figure. Similar elements or components between different figures may be identified by the use of similar digits. For example, 106 may reference element “06” in FIG. 1, and a similar element may be referenced as 206 in FIG. 2. A group or plurality of similar elements or components may generally be referred to herein with a single element number. For example, a plurality of reference elements 110-1 to 110-N (or, in the alternative, 110-1, . . . 110-N) may be referred to generally as 110. As will be appreciated, elements shown in the various embodiments herein can be added, exchanged, and/or eliminated so as to provide a number of additional embodiments of the present disclosure. In addition, the proportion and/or the relative scale of the elements provided in the figures are intended to illustrate certain embodiments of the present disclosure and should not be taken in a limiting sense.

FIG. 1 is a functional block diagram in the form of a computing system 100 including a host 102 and a memory system 104 in accordance with a number of embodiments of the present disclosure. As used herein, an “apparatus” can refer to, but is not limited to, any of a variety of structures or combinations of structures, such as a circuit or circuitry, a die or dice, a module or modules, a device or devices, or a system or systems, for example. The memory system 104 can include a one or more memory modules (e.g., single in-line memory modules, dual in-line memory modules, etc.). The memory system 104 can include volatile memory and/or non-volatile memory. In some embodiments, the computing system 100 (e.g., alternatively referred to as a computing device) can be a mobile computing device, such as a personal laptop computer, a digital camera, a smart phone, a memory card reader, and/or an internet-of-things (IoT) enabled device, as described herein.

The computing system 100 can include a system motherboard and/or backplane and can include and can include a memory access device, e.g., a processor (or processing unit), as described below. The computing system 100 can include separate integrated circuits or one or more of the host 102, the memory system 104, the memory controller 108, and/or the memory devices 110-1 to 110-N can be on the same integrated circuit. Although the example shown in FIG. 1 illustrates a computing system 100 having a Von Neumann architecture, embodiments of the present disclosure can be implemented in non-Von Neumann architectures, which may not include one or more components (e.g., CPU, ALU, etc.) often associated with a Von Neumann architecture.

As shown in FIG. 1, the host 102 can be coupled to the memory system 104 via one or more channels (e.g., channel 103). As used herein, a “channel” generally refers to a communication path by which signaling, commands, data, instructions, and the like are transferred between the host 102, the memory system 104, the memory controller 108, and/or the memory devices 110-1 to 110-N. Although not shown in FIG. 1 so as to not obfuscate the drawings, the memory devices 110-1 to 110-N can be coupled to the memory controller 108 and/or to the host 102 via one or more channels such that each of the memory devices 110-1 to 110-N can receive messages, commands, requests, protocols, data, or other signaling that is compliant with the type of memory associated with each of the memory devices 110-1 to 110-N.

The memory system 104 can, in some embodiments, be a universal flash storage (UFS) system. As used herein, the term “universal flash storage” generally refers to a memory system that is compliant with the universal flash storage specification that can be implemented in digital cameras, mobile computing devices (e.g., mobile phones, etc.), and/or other consumer electronics devices. In general, a UFS system utilizes one or more NAND flash memory devices such as multiple stacked 3D TLC NAND flash memory dice in conjunction with an integrated controller (e.g., the memory controller 108).

The memory system 104 can include volatile memory and/or non-volatile memory. In a number of embodiments, the memory system 104 can include a multi-chip device. A multi-chip device can include a number of different memory devices 110-1 to 110-N, which can include a number of different memory types and/or memory modules. For example, a memory system 104 can include non-volatile or volatile memory on any type of a module. In addition, as shown in FIG. 1, the memory system 104 can include a storage controller 108. Each of the components (e.g., the memory system 104, the memory controller 108, and/or the memory devices 110-1 to 110-N can be separately referred to herein as an “apparatus.” The memory controller 108 may be referred to as a “processing device” or “processing unit” herein.

The memory system 104 can provide main memory for the computing system 100 or could be used as additional memory and/or storage throughout the computing system 100. The memory system 104 can include one or more memory devices 110-1 to 110-N, which can include volatile and/or non-volatile memory cells. At least one of the memory devices 110-1 to 110-N can be a flash array with a NAND architecture, for example. Embodiments are not limited to a particular type of memory device. For instance, the memory system 104 can include RAM, ROM, DRAM, SDRAM, PCRAM, RRAM, and flash memory, among others.

In embodiments in which the memory system 104 includes non-volatile memory, the memory system 104 can include any number of memory devices 110-1 to 110-N that can include flash memory devices such as NAND or NOR flash memory devices. Embodiments are not so limited, however, and the memory system 104 can include other non-volatile memory devices 110-1 to 110-N such as non-volatile random-access memory devices (e.g., NVRAM, ReRAM, FeRAM, MRAM, PCM), “emerging” memory devices such as resistance variable (e.g., 3-D Crosspoint (3D XP)) memory devices, memory devices that include an array of self-selecting memory (SSM) cells, etc., or any combination thereof.

Resistance variable memory devices can perform bit storage based on a change of bulk resistance, in conjunction with a stackable cross-gridded data access array. Additionally, in contrast to many flash-based memories, resistance variable non-volatile memory can perform a write in-place operation, where a non-volatile memory cell can be programmed without the non-volatile memory cell being previously erased. In contrast to flash-based memories and resistance variable memories, self-selecting memory cells can include memory cells that have a single chalcogenide material that serves as both the switch and storage element for the memory cell.

In some embodiments, the memory devices 110-1 to 110-N include different types of memory. For example, the memory device 110-1 can be a non-volatile memory device, such as a NAND memory device, and the memory device 110-N can be a volatile memory device, such as a DRAM device, or vice versa. Embodiments are not so limited, however, and the memory devices 110-1 to 110-N can include any type and/or combination of memory devices.

The memory devices 110-1 to 110-N can be configured to store secure data. A portion of at least one of the memory devices 110-1 to 110-N can be configured as a replay protected memory block (RPMB), such as a RPMB 106 of the memory device 110-1 illustrated in FIG. 1. As used herein, the term “RPMB” refers to a portion of a memory device (e.g., the memory device 110) that is configured to store data in an authenticated and replay protected manner and that can be accessed only when the access to the RPMB is authenticated.

The RPMB 106 can be configured to store a cryptographic key, which can be used to decrypt and access data (e.g., secure data) stored in the memory devices 110-1 to 110-N. The data to be accessed by the cryptographic key can be encrypted/decrypted according to various cryptographic algorithms, such as Rivest-Shamir-Adleman (RSA), Elliptic-curve cryptography such as Elliptic Curve Digital Signature Algorithm (ECDSA), Elliptic-curve Diffie-Hellman (ECDH), Edwards-curve Digital Signature Algorithm (EdDSA), Paillier cryptosystem, Cramer-Shoup cryptosystem, YAK authenticated key agreement protocol, Advanced Encryption Standard (AES), Twofish algorithm, Blowfish algorithm, International Data Encryption Algorithm (IDEA), MD5 (MD5 message-digest algorithm), Hash-based message authentication code (HMAC), or any combination thereof.

The memory system 104 can further include a memory controller 108. The memory controller 108 can be provided in the form of an integrated circuit, such as an application-specific integrated circuit (ASIC), field programmable gate array (FPGA), reduced instruction set computing device (RISC), advanced RISC machine, system-on-a-chip, or other combination of hardware and/or circuitry that is configured to perform operations described in more detail, herein. In some embodiments, the memory controller 108 can comprise one or more processors (e.g., processing device(s), processing unit(s), etc.).

The memory controller 108 can control access to the memory devices 110-1 to 110-N. For example, the memory controller 108 can process signaling corresponding to memory access requests (e.g., read and write requests involving the memory devices 110-1 to 110-N) and cause data to be written to and/or read from the memory devices 110-1 to 110-N.

The memory controller 108 can further include an RPMB control component 105, which can be in the form of hardware and/or firmware (e.g., one or more integrated circuits) and/or software (e.g., instructions run or executed on a as the memory controller 108) for controlling access to the memory units 104. The RPMB control component 105 can control access to an RPMB (e.g., the RPMB 106) to receive data (e.g., cryptographic key) at and/or remove the data from the RPMB based on locations of the computing system 100. For example, the RPMB control component 105 can determine whether the computing system 100 and/or the memory system 104 is currently in and/or at a secure location or not and further determine whether to receive to and/or remove the cryptographic key from the RPMB 106 based on such determination associated with the secure location.

The memory controller 108 can be configured to store a logical-to-physical (L2P) table 107, which can be utilized to map logical addresses to physical addresses in the memory devices 110-1 to 110-N. As an example, an entry in the table 107 can include a reference to a physical address, such as a die, block, plane, and page of the memory devices 110-1 to 110-N to which a logical address received from the host 102 corresponds.

A location of the computing system 100 can be monitored (e.g., continuously) to determine (e.g., by the RPMB control component 105 and/or the administrator 214 illustrated in FIG. 2) whether the computing system 100 has entered or exited the secure location. The location of the computing system 100 can be monitored/determined using, for example, a global positioning service (GPS), an availability of a network identifier (ID) (e.g., in a network) assigned to the computing system 100, other self-locating technology/sensor, etc. included in the computing system 100.

A cryptographic key can be provided to the computing system 100 when it is determined that the computing system 100 has entered and/or is in a particular location, such as a secure location. In one example, the determination of whether the computing system 100 has entered and/or is in the secure location can be determined by, the RPMB control component 105, which then can request and receive the cryptographic key from the administrator (e.g., the administrator 214 illustrated in FIG. 2) upon approval of the request by the administrator. In another example, the determination that the computing system 100 has entered and/or is in the secure location can also be affirmatively made by the administrator (e.g., in collaboration with the computing system 100), which then can allow the computing system 100 to receive the cryptographic key. For example, the administrator can determine that the computing system 100 has entered the secure location responsive to a network ID assigned to the computing system 100 becoming available (e.g., appearing) in a network managed by the administrator. The received cryptographic key can be stored in an RPMB (e.g., the RPMB 106) of the memory devices 110-1 to 110-N.

The RPMB control component 105 can remove a cryptographic key stored in the RPMB 106 by erasing the cryptographic key both logically and physically. For example, the RPMB control component 105 can erase the cryptographic key logically by overwriting on one or more logical blocks (e.g., corresponding to physical blocks) storing the cryptographic key such that the overwritten logical blocks no longer correspond to (e.g., are translated to) the physical blocks. In some embodiments, overwriting on the logical blocks can be performed by reconfiguring the L2P table 107 such that the reconfigured table 108 no longer includes (e.g., a reference to) a physical address associated with the cryptographic key.

Subsequent to the cryptographic key being logically erased, the RPMB control component 105 can further trigger an RPMB purge operation. As used herein, the term “RPMB purge operation” refers to a specific operation as defined by the Joint Electron Device Engineering Council (JEDEC) that allows content (e.g., a cryptographic key) of an RPMB (e.g., the RPMB 106) to be physically and quickly erased. Accordingly, the RPMB purge operation performed on the RPMB 106 can physically erase the cryptographic key from the RPMB 106 such that no physical location (e.g., block) of the RPMB 106 store the cryptographic key anymore. Therefore, embodiments of the present disclosure can limit (e.g., prevent) secure data (e.g., stored in the RPMB 106) from being decrypted based on a location of the computing system 100 by selectively removing the cryptographic key.

In a non-limiting example, an apparatus (e.g., the computing device 100 and/or 200 illustrated in FIGS. 1-2, respectively) can include a memory array configured to store data and cryptographic information (e.g., the cryptographic key 212 illustrated in FIG. 2) for accessing the data. The apparatus can further include a controller (e.g., the controller 108 and/or 208 illustrated in FIGS. 1 and 2) coupled to the memory array. The controller can be configured to, in response to the apparatus moving from a first location (e.g., the location 220 illustrated in FIG. 2) to a second location, remove the cryptographic information from the memory array. In some embodiments, the apparatus can be a universal flash storage (UFS) device.

In some embodiments, the controller can be configured to physically erase the cryptographic information from the memory array responsive to the apparatus moving from the first location to the second location. In some embodiments, the controller can be further configured for a logical-to-physical mapping table (e.g., the table 107 illustrated in FIG. 1, respectively). In this example, the controller can be further configured to reconfigure the mapping table such that the reconfigured mapping table does not include a physical address associated with the cryptographic information.

In some embodiments, the controller can be configured to receive and store the cryptographic information in the memory array in response to the apparatus being determined to be in the first location. The controller can be configured to store the received cryptographic information a replay protected memory block (RPMB) (e.g., the RPMB 106 and/or 206 illustrated in FIGS. 1 and 2, respectively) of the memory array.

In another non-limiting example, an example apparatus (e.g., the computing device 100 and/or 200 illustrated in FIGS. 1-2, respectively) can include a memory array including a first portion configured to store data and a second portion configured to store cryptographic information (e.g., the cryptographic key 212 illustrated in FIG. 2) for accessing the data stored in the first portion. In some embodiments, the second portion can be a replay protected memory block (RPMB) (e.g., the RPMB 106 and/or 206 illustrated in FIGS. 1 and 2, respectively). The apparatus can further include a controller (e.g., the controller 108 and/or 208 illustrated in FIGS. 1 and 2) coupled to the memory array and configured to remove the cryptographic information from the memory array in response to the apparatus moving from a first location (e.g., the location 220 illustrated in FIG. 2) to a second location.

In some embodiments, the controller can be configured to overwrite a logical address corresponding to the second portion to logically erase the cryptographic information. Further, the controller can be configured to perform a purge operation on the second portion to physically erase the cryptographic information.

In some embodiments, the controller can be configured to decrypt, to access the data, the data stored in the first portion using the cryptographic information stored in the second portion. The controller is configured to receive the cryptographic information in response to the apparatus being determined to be in the first location. The controller can be configured to decrypt the data stored in the first portion using Rivest-Shamir-Adleman (RSA), Elliptic-curve cryptography such as Elliptic Curve Digital Signature Algorithm (ECDSA), Elliptic-curve Diffie-Hellman (ECDH), Edwards-curve Digital Signature Algorithm (EdDSA), Paillier, Cramer-Shoup, YAK authenticated key agreement protocol, Advanced Encryption Standard (AES), Twofish, Blowfish, International Data Encryption Algorithm (IDEA), MD5, or Hash-based message authentication code (HMAC), or any combination thereof. However, embodiments are not limited to a particular cryptographic encryption/decryption algorithm.

FIG. 2 is an example network 201 for preventing access to data based on locations in accordance with a number of embodiments of the present disclosure. A computing device 200 and an RPMB 206 can be analogous to the computing system 100 and RPMB 106 described in connection with FIG. 1.

As illustrated in FIG. 2, an area symbolically indicated by a dotted circle represents a secure location 220. As an example, a building and/or a facility can be configured as a secure location such that whether the computing device 200 is in a secure location is based on whether or not the computing device is in a building or facility. Although a single area is illustrated in FIG. 2 as being a secure location, embodiments are not so limited. For example, a secure location can include multiple (e.g., discontinuing) areas (e.g., multiple buildings and/or facilities can be configured as a secure locations), although not illustrated in FIG. 2.

As described herein, whether the computing device 200 is in the secure location 220 can be determined using, for example, a GPS, an availability of a network ID assigned to the computing device 200, other self-locating technology/sensor, etc. included in the computing device 200. In one example, it can be determined that the computing device 200 is in the secure location 220 when a network ID assigned to the computing device 200 becomes available (e.g., appears) in the network 201.

An administrator 214 can be configured as the “owner” of the network so as to generate a cryptographic key, determine whether to provide the cryptographic key to devices (e.g., within the area 220), and/or force the computing device 210 to remove the cryptographic key, for example, once the computing device 210 has left and/or is no longer in the secure location 220. In some embodiments, the administrator 214 can be a node. As used herein, a node may be referred to as a device and/or a data point. For example, a node can be, for example, an access point, gateway, firewall, load balancer, modem, hub, bridge, switch, host device, client device, router, workstation, and/or a server. A node can serve as a redistribution point and/or a communication endpoint of the network 201. For example, a node as a communication endpoint can send data as a source node and/or receive data as a destination node. For example, a node as a redistribution point can forward received data to another node.

The administrator can communicate with the computing device 200 in various locations (e.g., including the secure location 220) via a wireless (e.g., “over-the-air”) communication paths 216-1 to 216-X. The communication paths 216-1 to 216-X can be of various and/or different communication technologies, such as a device-to-device communication technology, cellular telecommunication technology, etc.

As used herein, the cellular telecommunication technology refers to a technology for wireless communication performed indirectly between a transmitting device and a receiving device via a base station. As used herein, a “base station” generally refers to equipment that generate and receive electromagnetic radiation within a particular frequency range and facilitate transfer of data or other information between the base station and computing devices (e.g., mobile computing devices such as smartphones, etc.) that are within a network coverage area of the base station. As used herein, the term “network coverage,” particular in the context of network coverage from a base station, generally refers to a geographical area that is characterized by the presence of electromagnetic radiation (e.g., waves having a particular frequency range associated therewith) generated by the base station. Several non-limiting examples of frequency ranges that a base station can generate and receive can include 700 MHz-2500 MHz (in the case of a 4G base station) or 28 GHz-39 GHz (in the case of a 5G base station).

As used herein, the device-to-device communication technology refers to a wireless communication performed directly between a transmitting device and a receiving device. As such, via the device-to-device communication technology, data to be transmitted by the transmitting device may be directly transmitted to the receiving device without routing through the intermediate network device.

The cryptographic key 212 can be provided to and/or removed from the computing device 200 based on a location of the computing device 200. For example, when it is determined that the computing device 200 has entered and/or is in the secure location 220, the computing device 200 is allowed to receive and store cryptographic key 212 in, for example, an RPMB 206 (e.g., of the memory device 110 illustrated in FIG. 1). As described herein, the cryptographic key 212 can be provided to the computing device 200 upon approval (e.g., by the administrator 216) of a request from the computing device 200 and/or by the administrator 216 in an affirmative manner such that the cryptographic key is provided without a request from the computing device 200.

While the computing device 200 is in the secure location 220, the cryptographic key 212 can remain in the RPMB 206. However, when it is determined that the computing device 200 has left and/or is no longer in the secure location 220, the cryptographic key 212 can be removed from the computing device 200 (e.g., RPMB 206). For example, the cryptographic key can be removed from the computing device 200 when the computing device 200 has left (e.g., moved out of) the secure location, as indicated by an arrow 218.

Removing the cryptographic key 212 can be initiated either by the computing device 200 or the administrator 214. In one example, the administrator 214 can monitor a location of the computing device 200 and can force the computing device 200 to remove the cryptographic key 212 when the administrator determines that the computing device 200 is not in the secure location 220. In another example, instructions stored in the computing device 200 (e.g., stored in the RPMB control component 105 illustrated in FIG. 1) can force the computing device 200 to remove the cryptographic key 212 when needed.

In some embodiments, the computing device 200 may be allowed to receive the cryptographic key 212 even when the computing device 200 is determined to be not in the secure location 220 (e.g., on a temporary or limited basis). For example, in some circumstances, the administrator 214 may allow (e.g., via the communication path 216-X) the computing device 200 to receive the cryptographic key 212 such that the computing device 200 can decrypt and access the data using the cryptographic key 212.

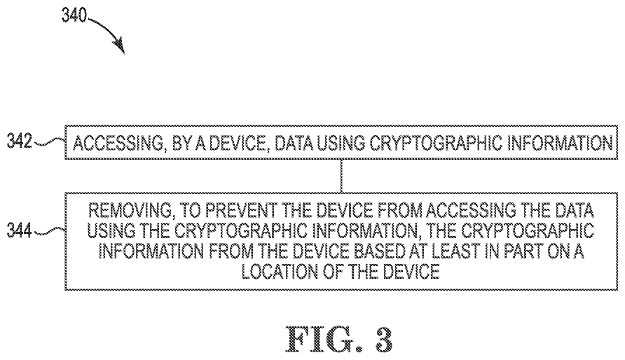

FIG. 3 is a flow diagram representing an example method 340 for preventing access to data based on locations in accordance with a number of embodiments of the present disclosure. The method 340 can be performed by processing logic that can include hardware (e.g., processing device, circuitry, dedicated logic, programmable logic, microcode, hardware of a device, integrated circuit, such as the memory controller 108 illustrated in FIG. 1, herein, etc.), software (e.g., instructions run or executed on a processing device, such as the memory controller 108 illustrated in FIG. 1, herein), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 342, data can be accessed by a device (e.g., the computing device 100 and/or 200 illustrated in FIGS. 1-2, respectively) using cryptographic information (e.g., the cryptographic key 212 illustrated in FIG. 2). In some embodiments, the data being accessed using the cryptographic information can include decrypting the data using the cryptographic information. At operation 344, the cryptographic information can be removed from the device based at least in part on a location of the device to prevent the device from accessing the data using the cryptographic information. For example, the cryptographic information can be removed from the device responsive to the device being determined to be not in a secure location.

In some embodiments, the cryptographic information can be received at the device (prior to accessing the data using the cryptographic information) responsive to the device being determined to be in a secure location (e.g., the location 220 illustrated in FIG. 2) to access the data using the cryptographic information while the device is in the secure location. In some embodiments, the cryptographic information can be received (prior to accessing the data using the cryptographic information) from a temporarily approved location (e.g., a location that is not the secure location 220) to access the data using the cryptographic information while the device is not in the secure location.

In some embodiments, the cryptographic key can be removed by being physically erased from the device. For example, a purge operation can be performed on a replay protected memory block (RPMB) (e.g., the RPMB 106 and/or 206 illustrated in FIGS. 1 and 2, respectively) of the device to physically erase the cryptographic information. Further, the cryptographic information can be logically erased (prior to physically erasing the cryptographic information) from the device by reconfiguring a logical-to-physical mapping table (e.g., the table 107 illustrated in FIG. 1) to not to include a physical address associated with the cryptographic information in the table.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
accessing, by a device, data using cryptographic information; and
removing, to prevent the device from accessing the data using the cryptographic information, the cryptographic information from the device based at least in part on a location of the device.

2. The method of claim 1, wherein removing the cryptographic information from the device based at least in part on the location of the device further comprises removing the cryptographic information from the device responsive to the device being determined to be not in a secure location.

3. The method of claim 1, further comprising, prior to accessing the data using the cryptographic information, receiving the cryptographic information responsive to the device being determined to be in a secure location to access the data using the cryptographic information while the device is in the secure location.

4. The method of claim 1, further comprising, prior to accessing the data using the cryptographic information, receiving the cryptographic information from a temporarily approved location to access the data using the cryptographic information while the device is not in the secure location.

5. The method of claim 1, wherein removing the cryptographic information from the device further comprises physically erasing the cryptographic information from the device.

6. The method of claim 5, wherein physically erasing the cryptographic information from the device further comprises performing a purge operation on a replay protected memory block (RPMB) of the device to physically erase the cryptographic information.

7. The method of claim 5, wherein, prior to physically erasing the cryptographic information, logically erasing the cryptographic information from the device by reconfiguring a logical-to-physical mapping table to not to include a physical address associated with the cryptographic information in the table.

8. The method of claim 1, wherein accessing the data using the cryptographic information further comprises decrypting the data using the cryptographic information.

9. An apparatus, comprising:
a memory array configured to store data and cryptographic information for accessing the data; and
a controller coupled to the memory array and configured to, in response to the apparatus moving from a first location to a second location, remove the cryptographic information from the memory array.

10. The apparatus of claim 9, wherein the controller is configured to physically erase the cryptographic information from the memory array responsive to the apparatus moving from the first location to the second location.

11. The apparatus of claim 9, wherein the controller is further configured for a logical-to-physical mapping table, and wherein the controller is further configured to reconfigure the mapping table such that the reconfigured mapping table does not include a physical address associated with the cryptographic information.

12. The apparatus of claim 9, wherein the apparatus is a universal flash storage (UFS) device.

13. The apparatus of claim 9, wherein the controller is configured to receive and store the cryptographic information in the memory array in response to the apparatus being determined to be in the first location.

14. The apparatus of claim 13, wherein the controller is configured to store the received cryptographic information a replay protected memory block (RPMB) of the memory array.

15. An apparatus, comprising:
a memory array comprising:
a first portion configured to store data; and
a second portion configured to store cryptographic information for accessing the data stored in the first portion; and
a controller coupled to the memory array and configured to remove the cryptographic information from the memory array in response to the apparatus moving from a first location to a second location.

16. The apparatus of claim 15, wherein the second portion is a replay protected memory block (RPMB).

17. The apparatus of claim 15, wherein the controller is configured to overwrite a logical address corresponding to the second portion to logically erase the cryptographic information.

18. The apparatus of claim 15, wherein the controller is configured to perform a purge operation on the second portion to physically erase the cryptographic information.

19. The apparatus of claim 15, wherein the controller is configured to decrypt, to access the data, the data stored in the first portion using the cryptographic information stored in the second portion.

20. The apparatus of claim 15, wherein the controller is configured to receive the cryptographic information in response to the apparatus being determined to be in the first location.
